(19) United States
(12) Patent Application Publication
(10) Pub. No.: US 2010/0001006 A1
(43) Pub. Date: Jan. 7, 2010

(54) Non-stick pattern-effect surface

(76) Inventor: Thomas James Workens, Sterling Heights, MI (US)

Correspondence Address: Thomas J Workens, 160 Valley Vista Dr, Camarillo, CA, 93010, US

(21) Appl. No.: 12/217,162

(22) Filed: Jul. 2, 2008

(51) Int. Cl. A47J 36/02

(52) U.S. Cl. 220/573.2

(57) ABSTRACT

This utility is a non-stick surface that will be used for cookware and cookware utensils, as well as any device used for food preparation, in which foods have the potential of sticking to the cooking surface, and surfaces used that will come in contact with cooking foods.

### DESCRIPTION

1. This utility is a surface shape and pattern, comprised of densely populated microscopic uniform shaped hills and microscopic uniform shaped invert hills, fused together to form one solid uniform hill and valley effect surface, absent of any flat and level areas.
2. The microscopic uniform shaped hills and microscopic uniform shaped invert hills, are all equal in size and shape.
3. The exact microscopic size of the microscopic uniform shaped hills and microscopic uniform shaped invert hills will be determined by the entity or person(s) who will utilize this non-stick pattern-effect surface.
4. The non-stick pattern-effect surface is produced on and within the objects applied to material surface.
5. The non-stick pattern-effect surface will be created on the surface of the cookware, using the material that the cookware is made from, forming one piece or whole object.

### DRAWING DESCRIPTION(S)

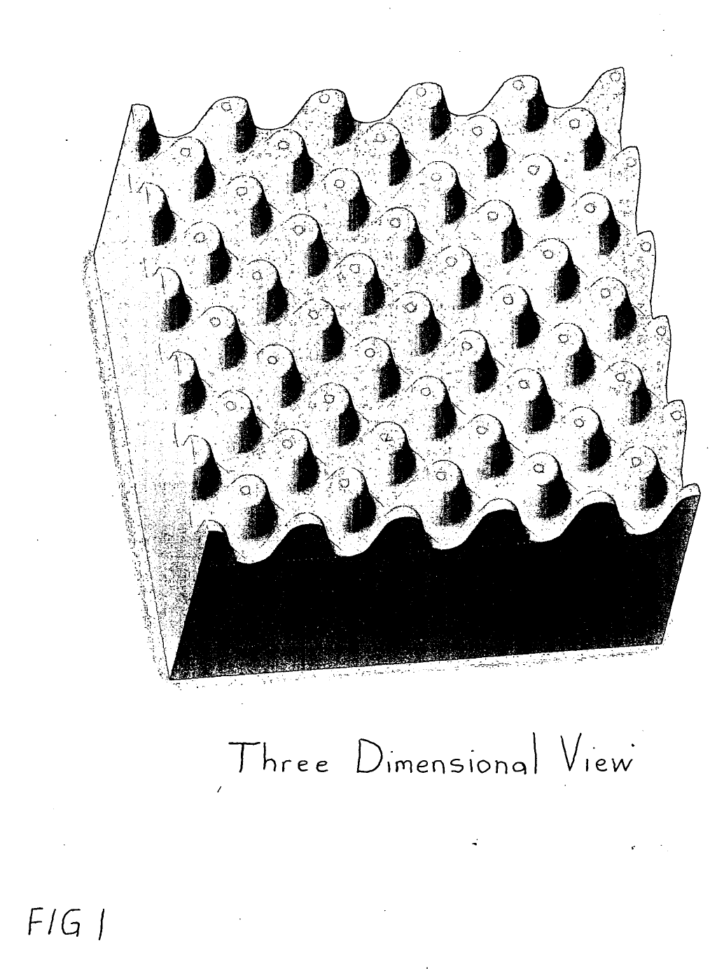

6. FIG. 1 shows the top view of densely populated microscopic uniform shaped hills and microscopic uniform shaped invert hills, fused together to form one solid uniform hill and valley effect surface, absent of any flat and level areas.

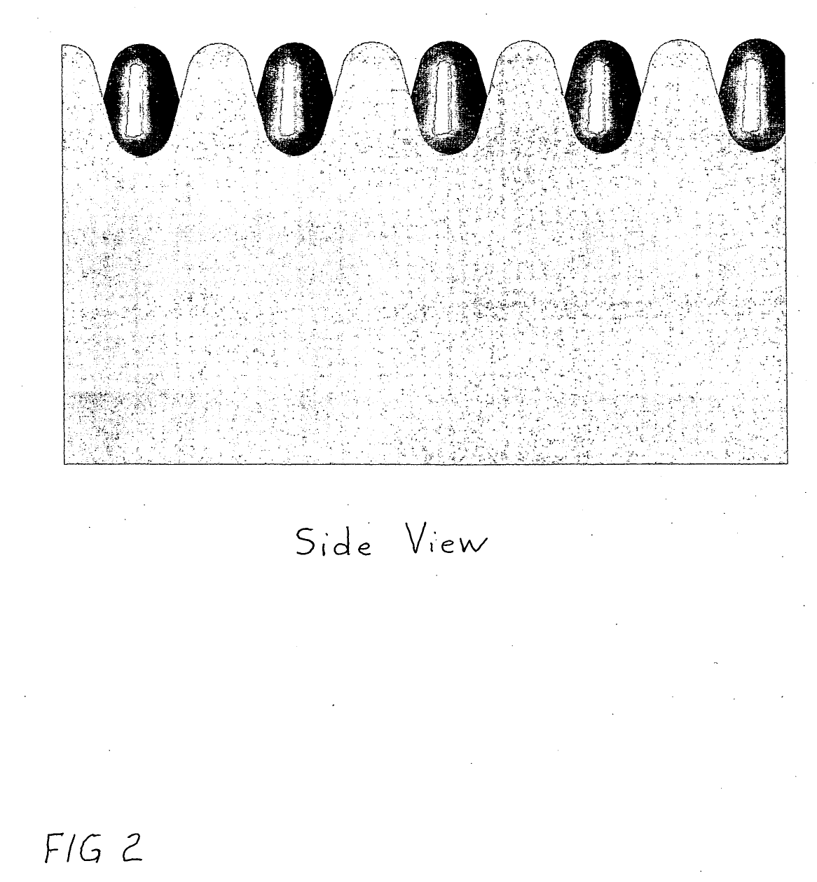

7. FIG. 2 shows one row, side view contour, of the microscopic uniform shaped hills and microscopic uniform shaped invert hills, fused together to form one solid uniform hill and valley effect surface, absent of any flat and level area.

1-16. (canceled)

17-23. (canceled)

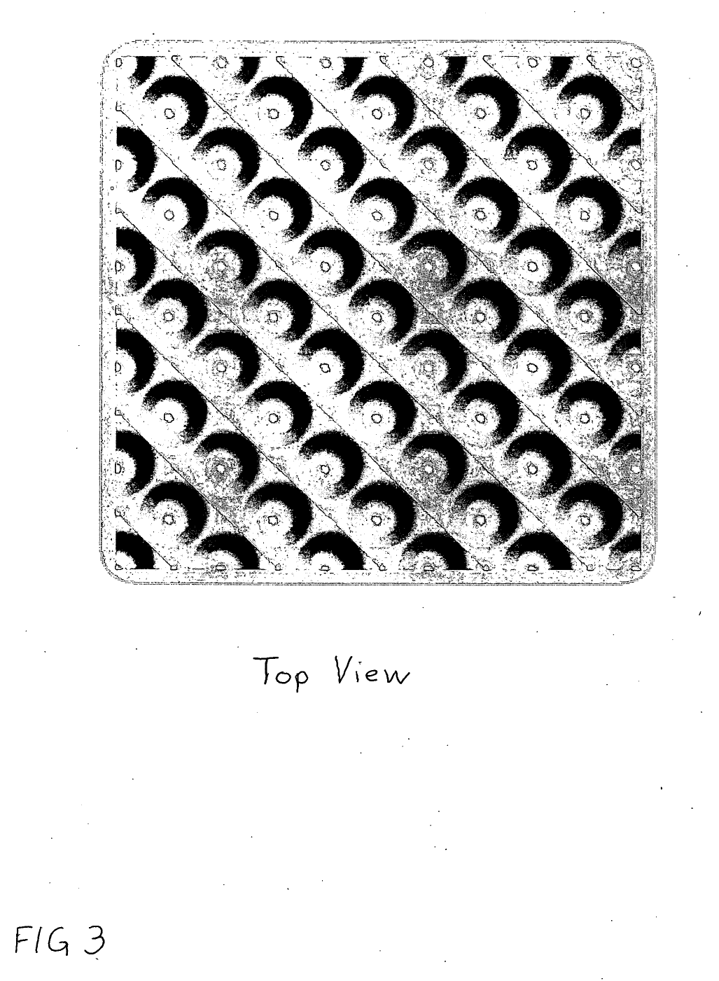

24. A non-stick pattern effect surface is comprised of microscopic uniform shaped hills and microscopic uniform shaped invert hills, fused together, with exact uniform size and shape, to form one solid uniform hill and valley effect surface, absent of any flat and level surface area as shown in FIG. 1 not shown in microscopic size, FIG. 2 not shown in microscopic size and FIG. 3 not shown in microscopic size, to cover fully the cookware cooking surface area, to better allow oils and juices to remain under foods, for better heat transfer and create a better non-stick cookware surface compared to products that do not utilize a non-stick pattern effect surface.

25. A non-stick pattern effect surface will be created and or produced and or manufactured on and with (in) the surface of the cookware, using the material that the cookware is made from, forming one piece or whole object.

26. A non-stick pattern effect surface comprised of microscopic uniform shaped hills and microscopic uniform shaped invert hills is accomplished or achieved through forge, forging, etching, tooling, a mold, molding, forms, laser, press, pressing, machine, machining or by any other idea or system new or existing not mentioned.

27. A non-stick pattern effect surface of claim 24 wherein it is an exact uniform size and shape will be determined by the application in which this process is used, its size may vary by the entity or person(s) involved in the utilization of this non-stick pattern effect surface, through testing, size will be determined for optimum performance in most cases.

28. A non-stick pattern effect surface of claim 25 wherein using the material that the cookware is made from can be utilized on and with (in) the materials surface of metal(s), ceramic(s), porcelain(s), plastic(s), etc . . .

29. The microscopic uniform shaped hills and the microscopic uniform shaped invert hills will be fused together, with exact uniform size and shape of claim 24 wherein can also be formed or shaped in- indifferent size, or not being of equal size, this may help or increase the non-stick pattern effect surface performance in creating a non-stick surface.

30. The microscopic uniform shaped hills and the microscopic uniform shaped invert hills will be fused together, with exact uniform size and shape of claim 24 wherein can also be formed or shaped in macroscopic, or not needing a visual aid or lens, or not of microscopic size, if the person(s) or entity wishes to do so, but the non-stick pattern may not perform as well.
